(19) United States
(12) Patent Application Publication
(10) Pub. No.: US 2013/0016755 A1
(43) Pub. Date: Jan. 17, 2013

(54) EXAMINER FOR BOILING POINT OF BRAKE OIL

(71) Applicant: Tien-Tsai TSENG, Taichung City (TW)

(72) Inventor: Tien-Tsai TSENG, Taichung City (TW)

(21) Appl. No.: 13/183,775

(22) Filed: Jul. 15, 2011

(51) Int. Cl. G01N 25/08

(52) U.S. Cl. 374/16

(57) ABSTRACT

A brake oil boiling point detector includes a handle, a positioning base, a thermometer, a heater, and a level detector. The positioning base is combined with the handle using a fixing part. The positioning base has spaces for brake oil to enter via through holes. The level detector heats and boils the brake oil when detecting that the height of the brake oil is sufficient for the heater to be immersed. The thermometer detects the boiling point and displays the temperature.

### BACKGROUND OF THE INVENTION

1. Field of Invention

The invention relates to an examiner for the boiling point of brake oil and, in particular, to an examining device that uses the boiling point to check water content of brake oil.

2. Related Art

Conventional brake oil examiners use electrodes to measure the impedance of brake oil to determine the conductivity thereof, thereby inferring the water content therein. However, this method involves large errors that may lead to inaccurate water content determination.

Using the boiling point to determine water content of brake oil is more accurate. A conventional brake oil boiling point examiner is shown in FIG. 11. The examiner has a tester 90 and a test bar 91. The tester 90 is connected to a battery using metal holders 901 at the end of the wire 900. The test bar 91 is electrically connected with the tester 90 via the test line 910 to transmit signals. As shown in FIG. 12, the test bar 91 has a heater 911 and a thermometer 912. The test bar 91 is immersed in the brake oil A to be tested. The heater 911 heats the brake oil A until it boils. The thermometer 912 then measures the boiling point, thereby determining whether the brake oil has deteriorated.

However, the tester 90 and the test bar 91 are separate. To use them, one has to hold the test bar 91 in one hand and to hold the tester 90 in the other or to leave it aside. The user has to constantly check both the tester 90 and the test bar 91 back and forth. Another problem is that if the heater 911 is not immersed in the brake oil A, the machine may be burned.

### SUMMARY OF THE INVENTION

An objective of the invention is to solve the above-mentioned problems by providing an examiner for the boiling point of brake oil. The thermometer display thereof is provided on the handle. The probe of the thermometer is extended from the handle. Therefore, the user can directly check the temperature change in the heated brake oil while examining the B. This is much more convenient.

Another objective of the invention is to provide a level detector in the positioning base thereof. The level detector checks the level of brake oil that enters the positioning base. Only when the brake oil level is higher than the heater will the heater start working. This mechanism prevents the heater from heating without brake oil around and thus avoids equipment damages and public dangers.

To achieve the above-mentioned objectives, the invention includes: a handle, a positioning base, a thermometer, a heater, and a level detector.

The handle has a circuit board therein. The circuit board is electrically connected with a power line extending out of the handle for electric power.

The positioning base is combined with the handle. The positioning base has a fixing part and at least a space for brake oil to enter. Each of the spaces is formed with a connecting hole corresponding to the positioning base to connect to the exterior. The positioning base is immersed into the brake oil vertically. The brake oil enters the spaces via the connecting holes.

The thermometer has a display part at the handle to display the temperature. A probe extends out of the handle. The heater is also disposed in the spaces, electrically connected to the circuit board in the handle and the power source for heating. The level detector is disposed at the positioning base and electrically connected to the circuit board for detecting the level of brake oil in the spaces. A signal is used to control the on and off of the circuit between the heater and the power source.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional perspective view of the invention;

FIG. 2 is a three-dimensional exploded view of the invention;

FIG. 3 is a cross-sectional view of the invention;

FIG. 4 is a cross-sectional view of the interior of the disclosed positioning base;

FIG. 5 is a cross-sectional view of the gap formed between the second through hole and the probe in the positioning base;

FIG. 6 is a schematic view of the level detector;

FIG. 7 is a schematic view of the attenuation of light emitted from the level detector and passing through the brake oil;

FIG. 8 shows the invention in use;

FIG. 9 is a schematic view of the brake oil entering the positioning base for detection according to the invention;

FIG. 10 is a schematic view showing the observation of temperature variation in the brake oil according to the invention;

FIG. 11 shows a conventional brake oil boiling point detector and its use; and

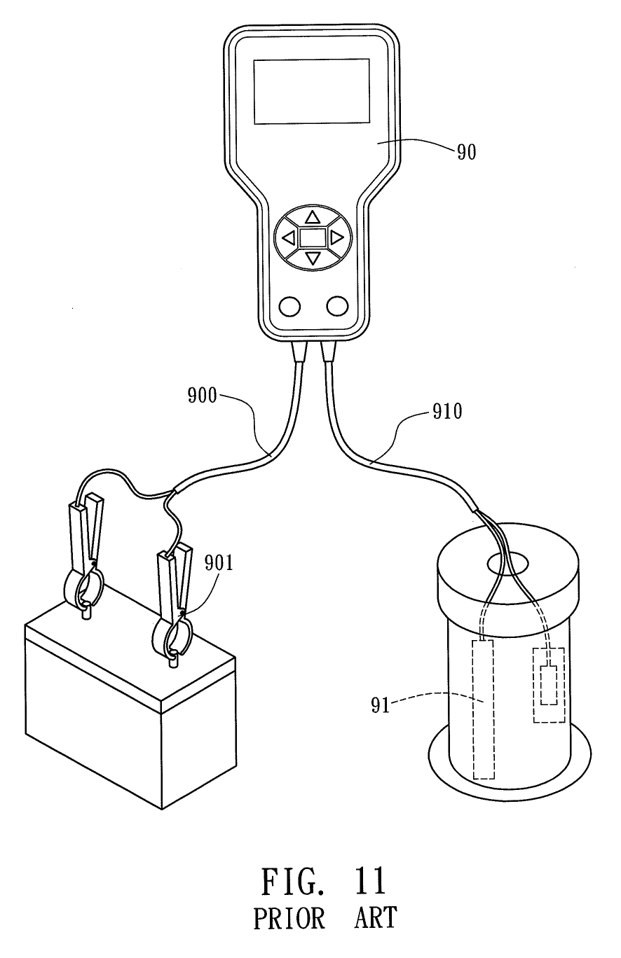

FIG. 12 is a cross-sectional view of a conventional test bar.

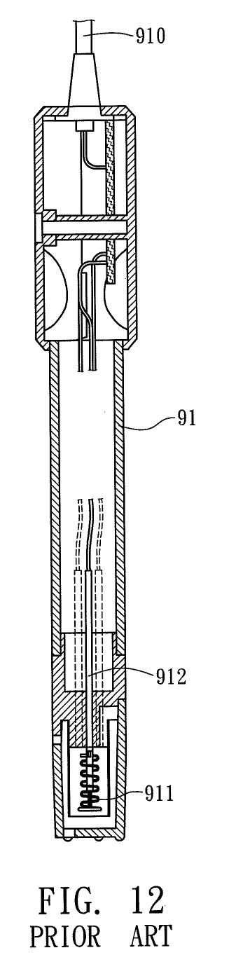

### DETAILED DESCRIPTION OF THE INVENTION

The present invention will be apparent from the following detailed description, which proceeds with reference to the accompanying drawings, wherein the same references relate to the same elements.

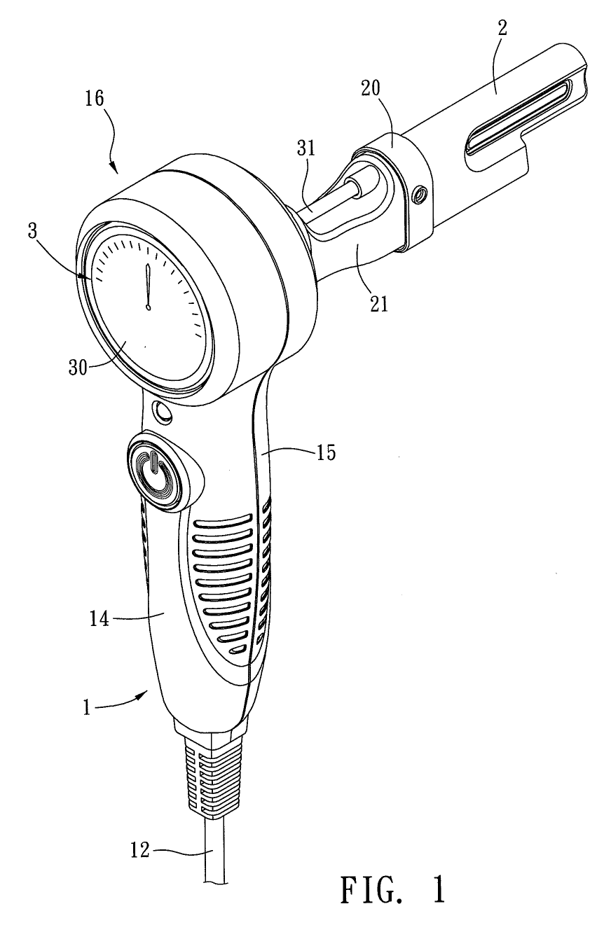

An embodiment of the disclosed brake oil boiling point detector is shown in FIGS. 1 to 3. It includes a handle 1, a positioning base 2, a thermometer 3, a heater 4, and a level detector 5.

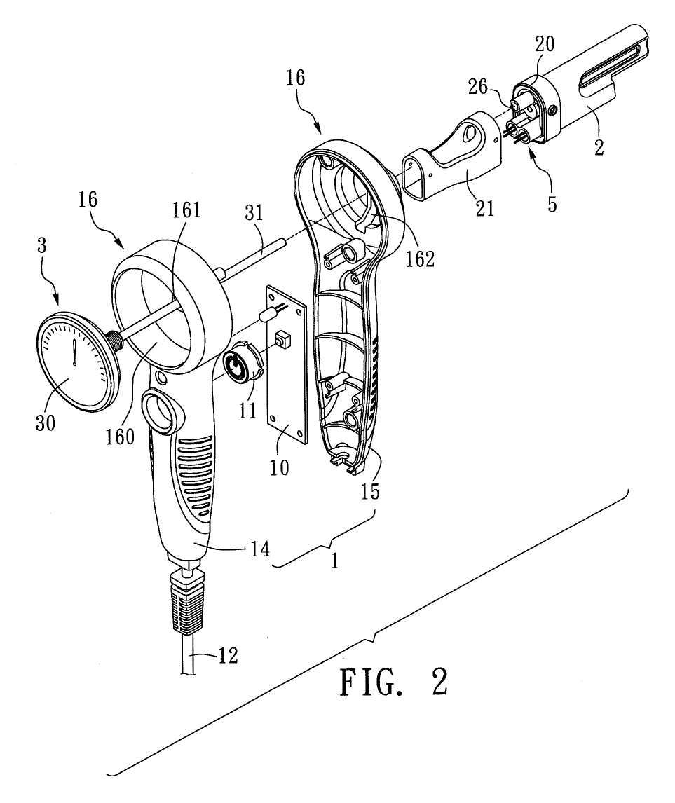

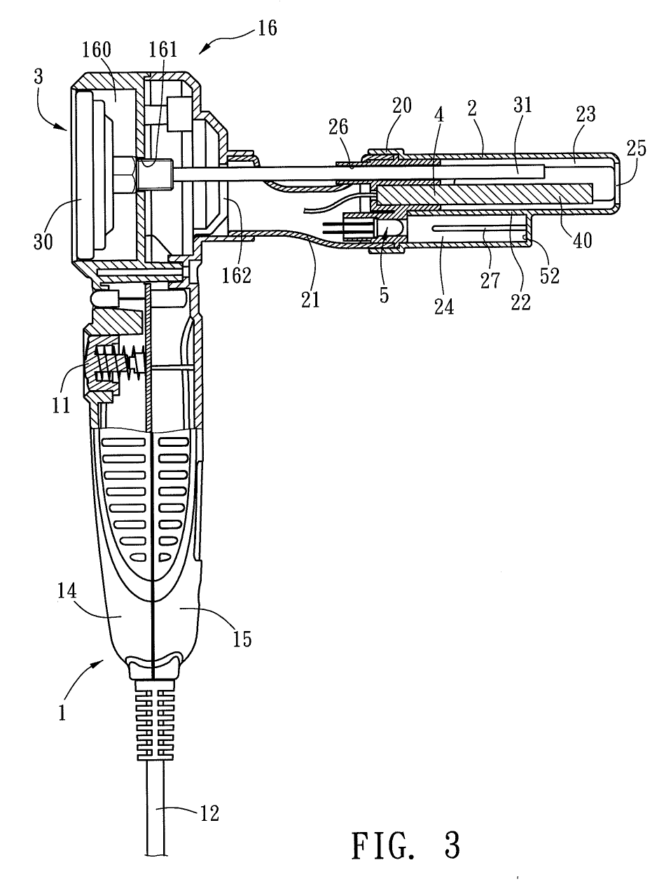

As shown in FIGS. 2 and 3, a circuit board 10 is disposed in the handle 1. The circuit board 10 has a heating switch 11 exposed from the handle 1 for its user to press. The heating switch 11 in this embodiment is a pressing switch. The circuit board 10 is electrically connected to a power source wire 12 extending out of the handle 1. The end of the power source wire 12 has two metal holders (not shown) to connect to a DC power source.

As shown in FIGS. 1 to 3, the handle 1 of this embodiment consists of a first shell 14 and a second shell 15. One end of the handle 1 forms a head part 16. The head part 16 has a recess space 160 in the first shell 14. The bottom of the recess space 160 has a first hole 161. The second shell 15 has a second hole 162 corresponding to the first hole 161.

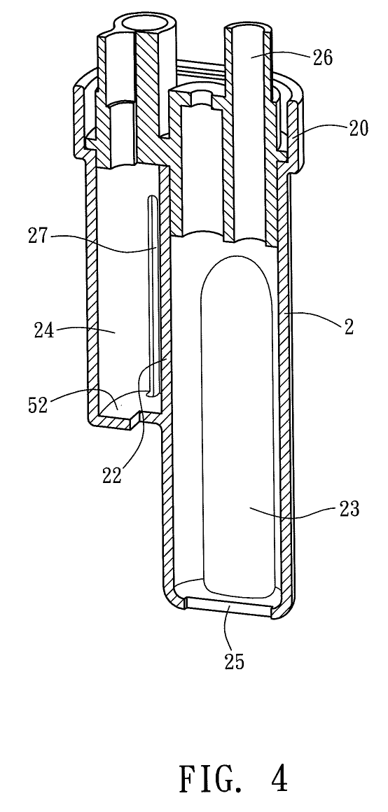

As shown in FIGS. 1 and 2, the positioning base 2 has a fixing part 20. In this embodiment, the fixing part 20 is connected to a hollow connecting tube 21 that is further combined to the handle 1. As shown in FIGS. 3 and 4, a divider 22 is disposed in the positioning base 2 and longitudinal when positioned upright. The longitudinal divider 22 divides the positioning base 2 into a first space 23 and a second space 24 on both sides of the divider 22. The positioning base 2 has a first through hole 25 at the bottom of the first space 23. The fixing part 20 at the top end of the firsts pace 23 has a second through hole 26 in the longitudinal direction. The positioning base 2 has a third through hole 27 on the side of the second space 24. The third through hole 27 is a longitudinal long hole. The first space 23 is connected to the exterior via the first through hole 25 and the second through hole 26. The second space 24 is connected to the exterior via the third through hole 27.

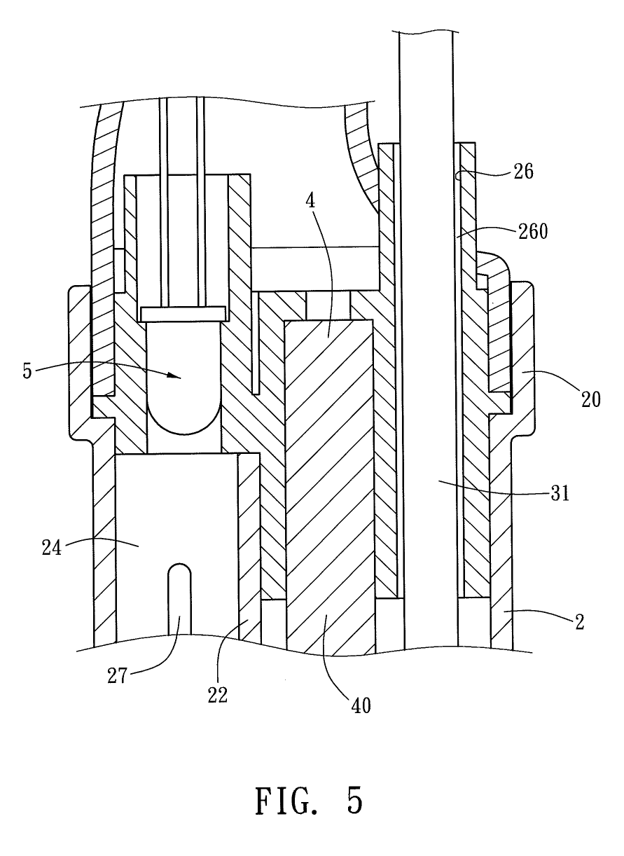

As shown in FIGS. 1 to 3, the thermometer 3 has a display part 30 and a probe 31. The display part 30 is inside the recess space 160 of the head part 16 on one end of the handle 1. The probe 31 goes through the first hole 161 and the second through hole and protrudes from the handle 1. The probe 31 goes through the connecting tube 21 and enters the first space 23 via the second through hole 26 from the fixing part 20 of the positioning base 2. As shown in FIG. 5, the diameter of the second through hole 26 is slightly larger than the probe 31 to form a gap 260. In this embodiment, the probe 31 extends out from the side of the handle 1 and is perpendicular to the handle 1. The positioning base 2 and the connecting tube 21 also extend from the side of the handle 1.

As shown in FIG. 3, the heater 4 is disposed in the first space 23 of the positioning base 2. The heater 4 is electrically connected with the circuit board 10 in the handle 1. As one presses the heating switch 11, the heater 4 is connected to the power source to start heating.

The level detector 5 in this embodiment is a reflective photo sensor. As shown in FIG. 3, the level detector 5 is installed at the fixing part 20 of the positioning base 2. Its sensing direction is toward the second space 24. The level detector 5 is electrically connected to the circuit board 10 for detecting the brake oil level in the second space. In this embodiment, the section of the first space 23 where the heater 4 is located is defined as the heating section 40. The detecting height of the level detector 5 is higher than the heating section 40 of the heater 4 for controlling the on and off of the connection between the heater 4 and the power source.

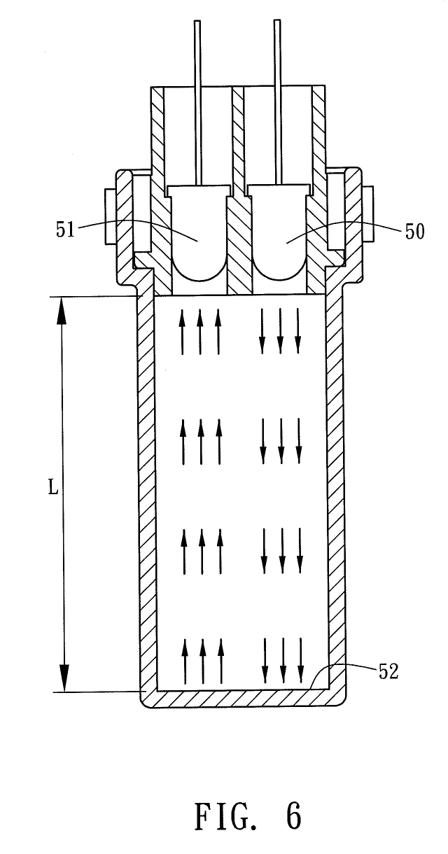

As shown in FIG. 6, the level detector 5 includes a light emitter 50, a light receiver 51, and a reflecting part 52. The light emitter 50 and the light receiver 51 are installed at the fixing part 20 of the positioning base 2. The reflecting part 52 is installed at the bottom of the positioning base 2 in the second space 24, keeping a detection distance L from the light emitter 50 and the light receiver 51.

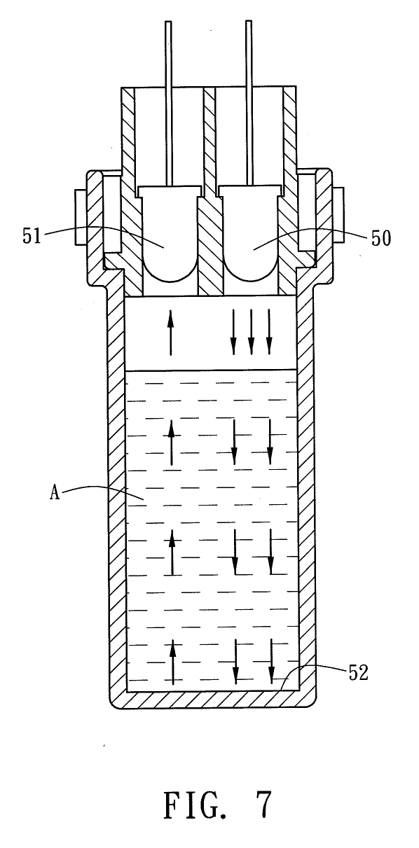

During the detection, as shown in FIG. 7, the light emitter 50 emits light that goes through the brake oil A and reflects from the reflecting part 52. The light receiver 51 receives the attenuated light and determines the difference between before and after the attenuation, thereby determining the level of the brake oil. When the brake oil level reaches the heating height, the heating switch 11 is activated for the heater 4 to start heating. The above-mentioned detecting height is the height of the light emitter 50 and the light receiver 51 of the level detector 5 in this embodiment. That is, the detector has to be higher than the heating section 40.

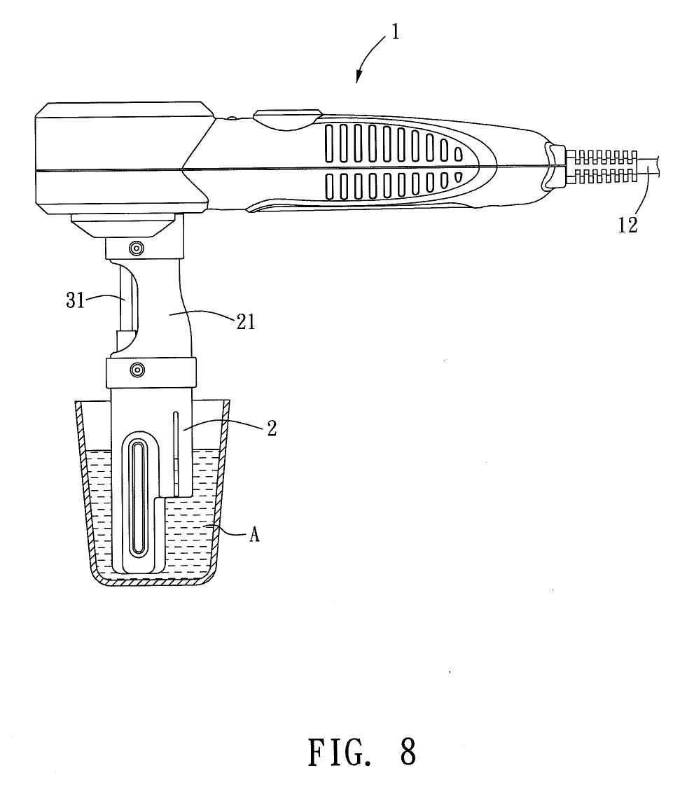

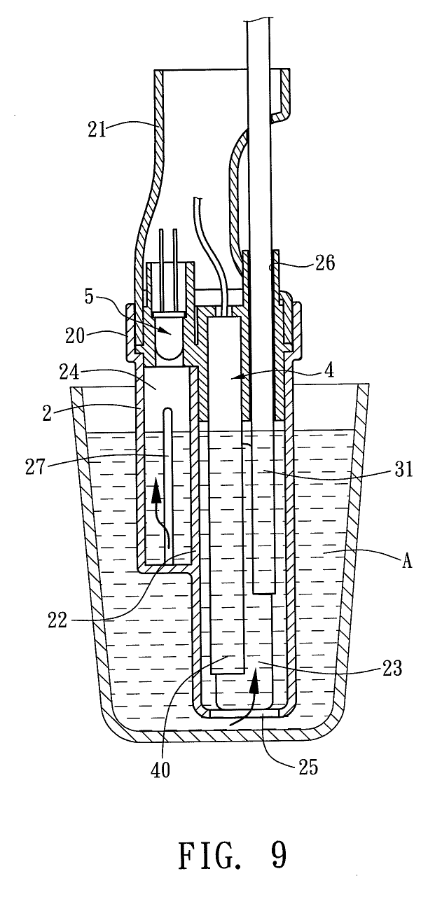

As shown in FIG. 8, the user holds the handle 1 to use the invention. The user vertically immerses the positioning base 2 into the brake oil A. As shown in FIG. 9, the brake oil A enters the first space 23 via the first through hole 25 and the second space 24 via the third through hole 27. The air in the first space 23 is expelled via the gap 260 between the second through hole 26 and the probe 31 while the brake oil A enters. Since the third through hole 27 is a longitudinal long hole, the air is expelled at the same time when the brake oil A enters the second space 24. In addition to allowing air to leave when the brake oil A enters the first space 23, the gap 260 also allows the brake oil A to flow out when the positioning base 2 is slightly tilted, preventing the brake oil A from directly flowing into the handle 1. When the height of the brake oil A in the first space 23 and the second space 24 gradually increase, the heater 4 of the first space 23 is gradually immersed in the brake oil A. When the level of the brake oil A reaches the heating height of the heating section 40 of the heater 4, the level detector 5 detects and outputs a signal that connects the heater 4 and the power source. When the user presses the heating switch 11, the heater 4 heats the brake oil A. The probe 31 then detects the temperature of the brake oil A. The user observes the temperature variation from the display part 30 on the handle 1 as the brake oil A is heated to its boiling point.

The invention has the following advantages:

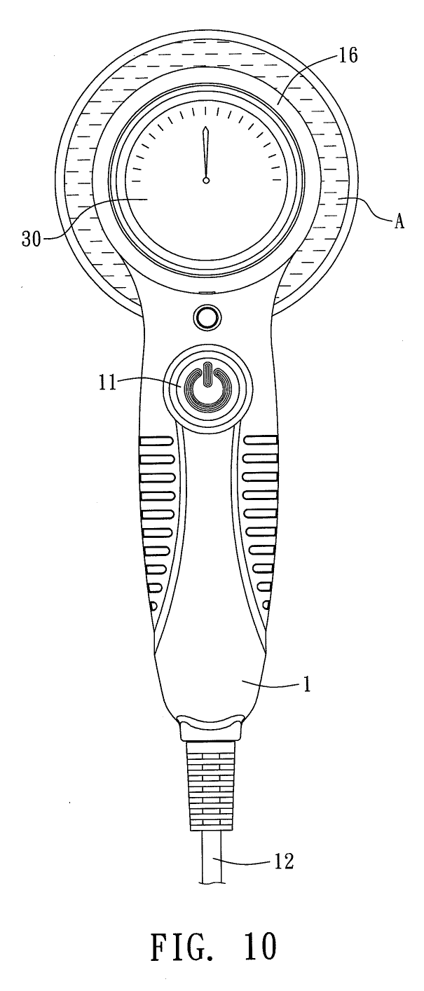

1. The display part 30 of the thermometer 3 is installed on the handle 1. As the brake oil A approaches its boiling point, as shown in FIG. 10, the user can observe the temperature variation directly from the display part 30.

2. The positioning base 2 has the level detector 5. When the level of the brake oil A entering the positioning base 2 is higher than the heater 4, the level detector 5 detects it and connects the heater 4 and the power source, thereby preventing the heater 4 from burning when it is not immersed in the brake oil A.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A brake oil boiling point detector, comprising:
a handle having a circuit board therein, the circuit board electrically connecting to a power source via a power line extending out of the handle;
a positioning base combined to the handle and having a fixing part and a plurality of spaces for brake oil to enter, the spaces having at least one through hole corresponding to the positioning base for communications with the exterior; wherein the positioning base is vertically immersed in the brake oil and the brake oil enters the spaces via the through holes;
a thermometer having a display part on the handle to display temperature and a probe extending from the handle;
a heater disposed in the spaces and electrically connected with the circuit board in the handle for heating when connected with the power source; and
a level detector disposed in the positioning base and electrically connected with the circuit board for detecting the level of the brake oil in the spaces and sending a signal to control the on and off of the connection between the heater and the power source.

2. The brake oil boiling point detector of claim 1, wherein the level detector is a reflective photo sensor that includes a light emitter, a light receiver, and a reflective part; the light emitter and the light receiver are installed on the fixing part of the positioning base; the reflective part is disposed at the bottom of the spaces of the positioning base, keeping a detection distance from the light emitter and the light receiver; the light emitter emits light, the light receiver receives attenuated light reflected from the reflective part and determines the level of the brake oil.

3. The brake oil boiling point detector of claim 2, wherein the positioning base has a divider that is longitudinal when upright; each of the spaces is divided by the longitudinal divider into a first space and a second space on both sides thereof; the probe of the thermometer is disposed in the first space, the heater is disposed in the first space, and the level detector is disposed in the second space.

4. The brake oil boiling point detector of claim 3, wherein the positioning base has a first through hole at the bottom of the first space, the fixing part at the top end of the firsts pace has a second longitudinal through hole, and the positioning base has a third through hole on the side of the second space; the third through hole is a longitudinal long hole; the first space communicates with the exterior via the first through hole and the second through hole; the second space communicates with the exterior via the third through hole; the probe enters the first space via the second through hole from the fixing part of the positioning base; and a venting gap is formed around the probe as the diameter of the second through hole is slightly larger than the probe.

5. The brake oil boiling point detector of claim 1, wherein a connecting tube connects the handle and the fixing part of the positioning base; the connecting tube and the positioning base ext3end from the side of the handle; the probe protrudes from the side of the handle and enters the spaces via the fixing part of the positioning base; and the probe is roughly perpendicular to the handle.

6. The brake oil boiling point detector of claim 2, wherein the section where the heater is located in the space is defined as a heating section and the height of the level detector is higher than the heating section of the heater.

7. The brake oil boiling point detector of claim 2, wherein the handle consists of a first shell and a second shell; one end of the handle forms a head part that has a recess space in the first shell for accommodating the display part; the bottom of the recess space has a first hole and the second shell has a second hole corresponding to the first hole; and the probe goes through the first hole and the second hole and extends from the handle.

8. The brake oil boiling point detector of claim 1, wherein the circuit board has a heating switch exposed from the handle for controlling the heater.
